(19) United States
(12) Patent Application Publication
(10) Pub. No.: US 2014/0130993 A1
(43) Pub. Date: May 15, 2014

(54) RETENTION SYSTEM FOR A PLIABLE SHEET

(71) Applicant: Slidetrack Blinds Pty Ltd, Glynde (AU)

(72) Inventor: Brian Lionel ZWAR, Glynde (AU)

(73) Assignee: SLIDETRACK BLINDS PTY LTD, Glynde (AU)

(21) Appl. No.: 14/077,504

(22) Filed: Nov. 12, 2013

(30) Foreign Application Priority Data
Nov. 12, 2012 (AU) 2012904971

(51) Int. Cl. E06B 5/00

(52) U.S. Cl. CPC E06B 5/00
USPC 160/371

(57) ABSTRACT

This invention relates to a retention system for a pliable sheet comprising a support comprising a channel having an opening, a spline for capturing a portion of the pliable sheet between itself and the channel, and an attachment securable with respect to the support so as extend across at least a portion of the opening to the channel and prevent escape of the spline therefrom. An associated frame assembly is also disclosed.

### CROSS-REFERENCE TO RELATED APPLICATIONS

This application claims the benefit of Australian Provisional Patent Application No 2012904971 titled “A RETENTION SYSTEM FOR A PLIABLE SHEET” and filed on 12 Nov. 2012, the entirety of which is incorporated by reference herein.

### TECHNICAL FIELD

The present invention relates to a retention system for a pliable sheet. In a particular form the present invention relates to a retention system comprising a frame extending around a perimeter of a pliable sheet so as to hold the sheet taut therein, such as would be found in a screen door or window.

### BACKGROUND

It is known to retain a sheet of flyscreen material about its perimeter by capturing a portion of the sheet between a flexible, resilient spline and a u-shaped channel provided by a perimeter frame.

The clamping force provided by such an arrangement is limited, making it unsuitable for applications where the sheet is subject to high pull-out loads of the type created when the fabric is a larger size and/or is exposed to wind, because in these cases the pliable sheet will pull the spline out of the u-shaped channel.

It is against this background and the problems and difficulties associated therewith that the present invention has been developed.

Certain objects and advantages of the present invention will become apparent from the following description, taken in connection with the accompanying drawings, wherein, by way of illustration and example, an embodiment of the present invention is disclosed.

### SUMMARY

According to a first aspect, there is provided a retention system for a pliable sheet comprising a support comprising a channel having an opening, a spline for capturing a portion of the pliable sheet between itself and an interior of the channel, an attachment securable with respect to the support so as extend across at least a portion of the opening to the channel and prevent escape of the spline therefrom.

In one form, the support is a frame member. In an alternative, the support may be any one of a column or a wall.

In one form, the attachment comprises a projection, which in use, is located adjacent to the spline to prevent its escape.

In one form, the attachment comprises a projection, which in use, is directed into the channel to bear against the spline.

In one form, the projection is substantially continuous along the length of the attachment. In an alternative, the attachment comprises a plurality of projections which are spaced apart at intervals along its length.

In one form, the attachment substantially conceals the channel.

In one form, the attachment is securable to the frame member by way of any of a hinge, snap-fit, clipping, an adhesive or a fastener.

In one form, the frame member forms part of a frame extending around a perimeter of the pliable sheet to hold the sheet taut therein.

In one form, the frame member comprises a further channel for a fastener.

In one form, in use, the attachment substantially conceals both channels.

In one form, the frame member is a unitary component of substantially constant cross section along its length.

In one form, the frame member is manufactured by extrusion. In one form, the frame member is manufactured from aluminium. In an alternative it is manufactured from an engineering plastic.

In one form, the attachment is a unitary component of substantially constant cross section along its length.

In one form, the attachment is manufactured by extrusion. In one form, the attachment is manufactured from aluminium. In an alternative it is manufactured from an engineering plastic.

According to a second aspect, there is provided a frame assembly comprising a frame extending around a perimeter of a pliable sheet so as to hold the sheet taut therein, the frame being comprised of one or more frame members, the or each frame member comprising a channel having an opening, a spline for capturing a portion of the pliable sheet between itself and an interior of the channel, an attachment securable with respect to the frame member so as extend across at least a portion of the opening to the channel and prevent escape of the flexible spline therefrom.

In one form, the frame is rectilinear, although it could conceivably be manufactured in a circular shape, or even that of another polygon.

In one form, the frame is a door frame. In an alternative, the frame is a window frame. In a further alternative, the frame is a picture frame. In yet a further alternative, the frame is a banner frame.

For the purpose of this specification the term “pliable material” is intended to include any of screen materials, fabrics, canvas, PVC etc. This material may be light blocking or at least partially or fully light transmitting as the intended application dictates.

A detailed description of one or more embodiments of the invention is provided below along with accompanying Figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

In order to further understand the invention, preferred embodiments, will now be described. However, it will be realised that the scope of the invention is not to be confined or restricted to the details of the embodiments described below. Variations and alterations that would be readily apparent to a person skilled in the art are deemed as being incorporated within the scope of the invention.

### BRIEF DESCRIPTION OF DRAWINGS

Embodiments of the present invention will be discussed with reference to the accompanying drawings wherein:

FIG. 1 is a cross-sectional view through a support in the form of a frame member forming part of a frame extending around a perimeter of a pliable sheet;

FIG. 2 is a cross-sectional view through the frame member of FIG. 1, and a mounting rail therefor;

FIG. 3 is a cross-sectional view through the frame member during insertion thereof in the mounting rail; and

FIG. 4 is a cross-sectional view through the frame member once inserted in the mounting rail.

In the following description, like reference characters designate like or corresponding parts throughout the Figures.

### DESCRIPTION OF EMBODIMENTS

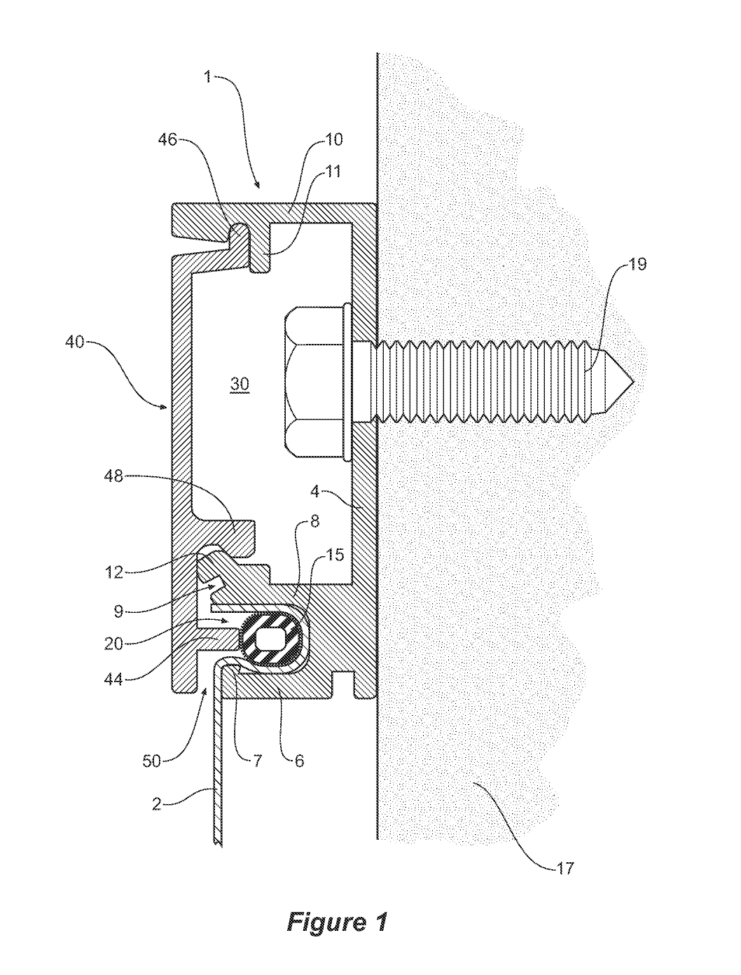

Referring now to FIG. 1, where there is shown a cross-sectional view through a support in the form of a frame member 1 forming part of a frame extending around a perimeter of a pliable sheet 2 to hold the sheet 2 taut therein.

The frame member 1 is an elongate and unitary component of substantially constant cross section along its length, which, in this embodiment is formed by extrusion of aluminium.

The frame member 1 comprises a base portion 4, from which there extend three spaced apart, substantially parallel walls 6, 8 and 10, between which there is defined two parallel channels 20 and 30, where channel 20 is considerably narrower than channel 30.

In use, the frame member 1 may be secured to a supporting surface 17 by driving a screw 19 through base portion 4 and into the supporting surface 17. Alternatively, the frame member 1 could be any one of nailed, glued or riveted to the supporting surface 17.

The sheet 2 is secured to the frame member 1 (and the frame and supporting surface 17 in turn) by means of an elongate elastomeric strip known as a spline 15 being forced into channel 20 with an interference fit, trapping a portion of the sheet 2 between itself and the interior of the channel 20 in the process. Wall 6 includes an inwardly directed lip 7 to assist retention of spline 15.

Wall 8 comprises an elongate slot 9, along which a blade of a knife can be run to neatly trim a free edge of the sheet 2.

There is provided an attachment 40 for the frame member 1, in the form of an elongate and unitary strip of substantially constant cross section along its length, which, in this embodiment is formed by extrusion of aluminium or engineering plastic.

In use, attachment 40 is securable with respect to the frame member 1 so as extend across the openings to, and thereby conceal channels 20 and 30. In other words, attachment 40 serves as a ‘cover strip’. More importantly however, attachment 40 further comprises a projection 44, which, in use, is directed into the channel 20 to be adjacent to or bear against the spline 15. In cases where projection 44 bears against the spline 15 it will compress the spline 15 and force this against the walls 6 and 8 of the channel 20, but either way, it will prevent escape of both the flexible spline 15 and the pliable sheet 2 in turn.

In the illustrated embodiment, attachment 40 is securable with respect to the frame member 1 by way of clipping or ‘snap-fit’. Along a first edge of the attachment 40 there extends a bead 46 which locates in a shallow channel provided in an inwardly directed (with respect to channel 30) lip 11 of wall 10. Attachment 40 further comprises a cantilever snap fit which engages in an inwardly directed (with respect to channel 30) lip 12 of wall 8.

There is a slot 50 defined between an edge of attachment 40 and a tip of wall 6, through which the sheet 2 passes.

From all of the above, it should now be apparent then that in addition to forming a cover strip, attachment 40 also greatly improves retention of the flexible spline 15 and the pliable sheet 2 in turn.

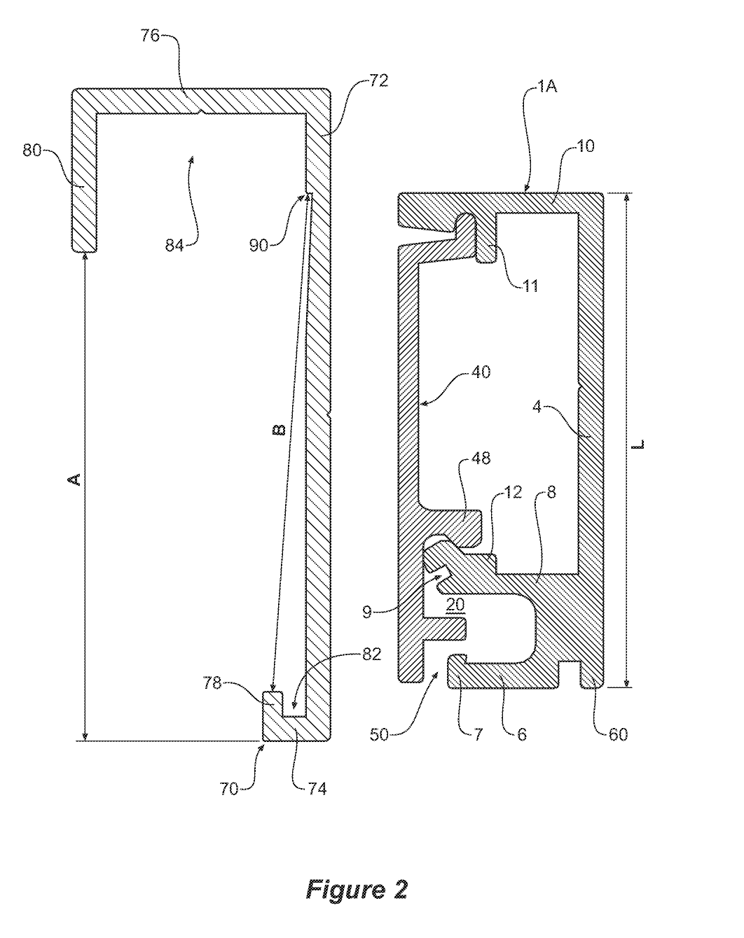

Referring now to FIG. 2, where there is illustrated a frame member 1A near identical to frame member 1, but differing in that this further comprises a locating tab 60 for assisting nesting of frame member 1A in a mounting rail 70. This way, the frame can be fitted in the mounting rails 70 and then fixed in position once the proper alignment has been achieved.

Mounting rail 70 is an elongate and unitary component of substantially constant cross section along its length, which, in this embodiment is formed by extrusion of aluminium.

The mounting rail 70 comprises a base 72 from which there extends two spaced apart, substantially parallel walls 74 and 76, each of which comprises in an inwardly (toward each other) directed lip, being namely lip 78 for wall 74, and lip 80 for wall 76. Wall 74 is considerably shorter than wall 76, and lip 78 is considerably shorter than lip 80. In this way wall 74 and lip 78 define between them a narrow channel 82, while base 72, wall 76 and lip 80 define between them a much wider and deeper channel 84.

Channel 82 is about as deep as it is wide, and its width has been selected to receive the locating tab 60 of frame member 1A.

Channel 84 has a width selected to receive the wall 10 of frame member 1A.

The base 4 of frame member 1A has a length L which is inclusive of locating tab 60, but the distance A between the lips 78 and 80 is slightly less than the length L (i.e. L>A); in this way, once frame member 1A is nested in mounting rail 70 it cannot inadvertently escape. However, this geometry also prevents insertion of frame member 1A into mounting rail 70. This difficulty is overcome by gradually thinning base 72 by tapering this down so as to create a relief shoulder 90 in an inner surface thereof The distance B from lip 78 to relief 90 is selected to be slightly greater than the length L (i.e. B>L) of the frame member 1A.

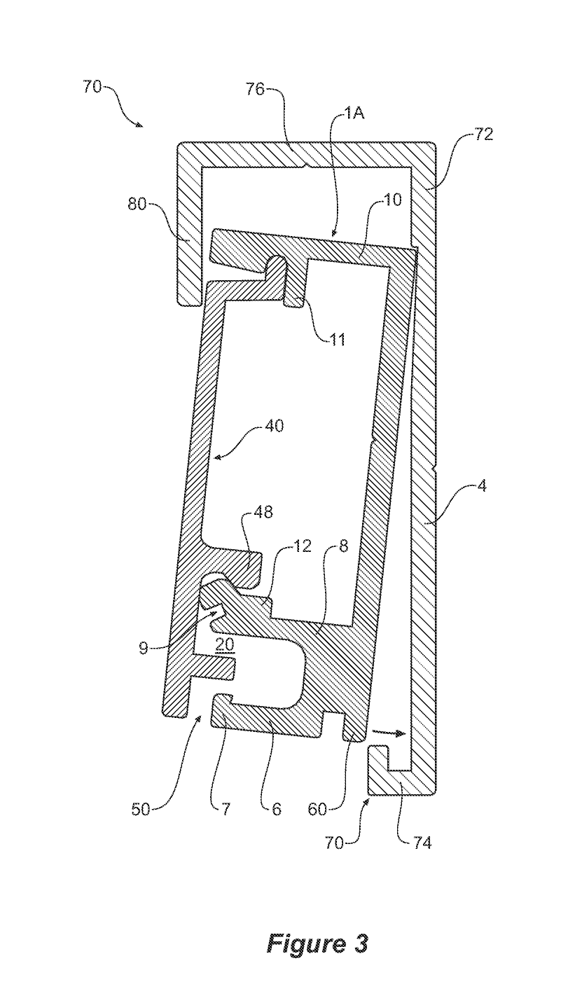

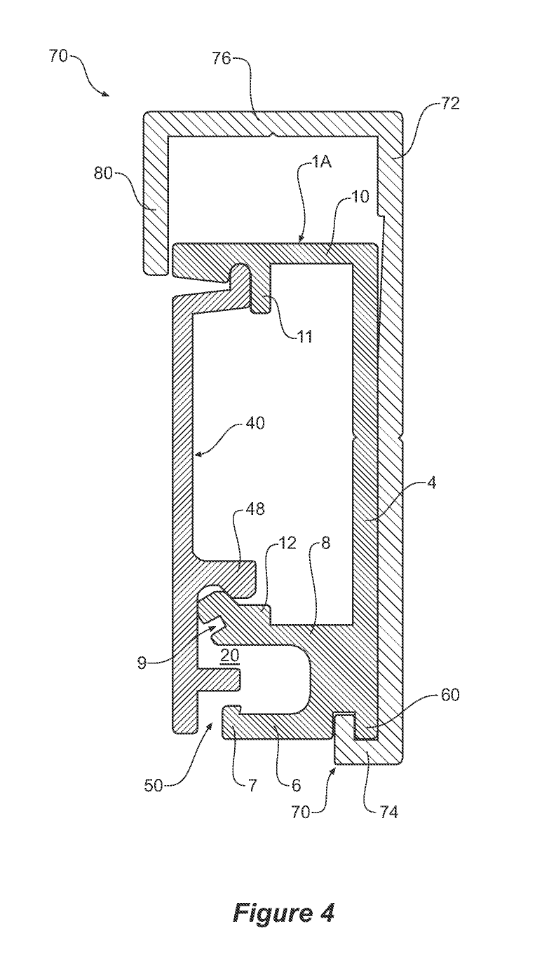

It can be seen from FIG. 3 how in use the mounting rail 70 may be secured to a supporting surface 17 by any suitable method, and wall 10 end of frame member 1A inserted into mounting rail 70 using relief shoulder 90, by passing the length L of frame member 1A through the gap defined by distance B until the base 4 of frame member 1A abuts base 72 of mounting rail 70 (see FIG. 4), at which point locating tab 60 locates in channel 82. Tensioning of the pliable sheet 2 retained by the frame member 1A will urge the locating tab 60 into channel 82 ensuring that the frame member 1A is retained in the mounting rail 70.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

What is claimed is:

1. A retention system for a pliable sheet comprising a support comprising: a channel having an opening, a spline for capturing a portion of the pliable sheet between itself and an interior of the channel, and an attachment securable with respect to the support so as extend across at least a portion of the opening to the channel and prevent escape of the spline therefrom.

2. The retention system of claim 1, wherein the attachment comprises a projection, which in use, is located adjacent to the spline.

3. The retention system of claim 1, wherein the attachment comprises a projection which is directed into the channel to bear against the spline.

4. The retention system of claim 2, wherein the projection is substantially continuous along the length of the attachment.

5. The retention system of claim 2, wherein the attachment comprises a plurality of projections which are spaced apart at intervals along its length.

6. The retention system of claim 1, wherein the attachment substantially conceals the channel.

7. The retention system of claim 1, wherein the support is a frame member.

8. The retention system of claim 7, wherein the frame member forms part of a frame extending around a perimeter of the pliable sheet to hold the sheet taut therein.

9. The retention system of claim 7, wherein the frame member comprises a further channel, and in use, the attachment substantially conceals both channels.

10. The retention system claim 7, wherein the frame member is a unitary component of substantially constant cross section along its length.

11. The retention system of claim 1, wherein the attachment is a unitary component of substantially constant cross section along its length.

12. A frame assembly comprising a frame extending around a perimeter of a pliable sheet so as to hold the sheet taut therein, the frame being comprised of one or more frame members, the or each frame member comprising a channel having an opening, a spline for capturing a portion of the pliable sheet between itself and an interior of the channel, and an attachment securable with respect to the frame member so as extend across at least a portion of the opening to the channel and prevent escape of the flexible spline therefrom.

13. The frame assembly of claim 12, wherein the frame is a door frame.

14. The frame assembly of claim 12, wherein the frame is a window frame.

15. The frame assembly of claim 12, wherein the frame is a picture frame.

16. The frame assembly of claim 12, wherein the frame is a banner frame.
